(19) United States
(12) Patent Application Publication
(10) Pub. No.: US 2026/0233752 A1
(43) Pub. Date: Aug. 13, 2026

(54) DRIVING ASSISTANCE DEVICE AND DRIVING ASSISTANCE METHOD

(71) Applicants: DENSO CORPORATION, Kariya-city (JP); J-QuAD DYNAMICS Inc., Tokyo (JP)

(72) Inventor: Riki EGAMI, Tokyo (JP)

(21) Appl. No.: 19/536,892

(22) Filed: Feb. 11, 2026

(30) Foreign Application Priority Data
Feb. 13, 2025 (JP) 2025-021585

(51) Int. Cl. B60W 50/14; B60W 30/06; B60W 30/095

(52) U.S. Cl. CPC B60W 50/14; B60W 30/06; B60W 30/0956

(57) ABSTRACT

A driving assistance device includes a position information acquisition unit that acquires the vehicle position, a driving information acquisition unit that acquires driving information, a surrounding information acquisition unit that acquires surrounding information, a memory unit that stores a reference position, reference driving information, and reference surrounding information, which is surrounding information on a driving route from the reference position to a target position, in association with each other, and a control unit that performs driving assistance control to cause the vehicle to travel the driving route. In response to an accuracy of the vehicle position being equal to or less than a threshold accuracy, the control unit performs driving assistance control using the surrounding information, a reference position whose distance from the vehicle position is equal to or less than a threshold distance, and reference surrounding information that is associated with reference driving information whose similarity with the driving information at the vehicle position is equal to or greater than a threshold similarity.

### CROSS-REFERENCE TO RELATED APPLICATION

This application is based on and claims the benefit of priority from earlier Japanese Patent Application No. 2025-21585 filed on Feb. 13, 2025, the description of which is incorporated herein by reference.

### TECHNICAL FIELD

The present disclosure relates to a driving assistance device and a driving assistance method.

### BACKGROUND

A driving assistance technology, as a driving assistance device, is known that uses the estimated current vehicle position, determined by localization technology that compares information about targets around the vehicle acquired during past traveling with information about targets around the vehicle acquired at the present time, to assist in driving the vehicle. JP 2019-137158 A describes a technology that uses localization technology to assist in autonomous parking in a pre-memorized parking area. JP 2023-35026 A describes a technology that uses localization technology to determine whether a vehicle is positioned at a start position of a driving route for autonomous parking.

### SUMMARY

According to one aspect of the present disclosure, a driving assistance device is provided. The driving assistance device includes a position information acquisition unit that acquires a vehicle position, which is a current position of the vehicle, a driving information acquisition unit that acquires driving information related to a driving state of the vehicle, a surrounding information acquisition unit that acquires surrounding information indicating targets positioned around the vehicle, a memory unit that stores a reference position, reference driving information, and reference surrounding information, which is surrounding information on a driving route from the reference position to a target position, in association with each other, and a control unit that performs driving assistance control to cause the vehicle to travel the driving route. In response to an accuracy of the vehicle position being equal to or less than a predetermined threshold accuracy, the control unit performs the driving assistance control using the surrounding information and the reference surrounding information associated with the reference position whose distance from the vehicle position is equal to or less than a predetermined threshold distance and the reference driving information whose similarity with the driving information is equal to or greater than a predetermined threshold similarity.

### BRIEF DESCRIPTION OF THE DRAWINGS

The above features of the present disclosure will be made clearer by the following detailed description, given referring to the appended drawings. In the accompanying drawings:

FIG. 1 shows a schematic diagram of a configuration of a driving assistance system;

FIG. 2 shows a flowchart of an example of a driving assistance process;

FIG. 3 shows a flowchart of an example of a driving assistance control process; and

FIG. 4 shows an explanatory diagram of the driving assistance control process.

### DETAILED DESCRIPTION OF THE PREFERRED EMBODIMENTS

An accuracy of positioning using Global Navigation Satellite System (GNSS) such as GPS (Global Positioning System) may be reduced. In this case, there is a possibility that the position of the vehicle may not be estimated correctly using localization technology.

The present disclosure has been made to solve the above-mentioned problems, and can be realized in the following aspect.

According to one aspect of the present disclosure, a driving assistance device is provided. The driving assistance device includes a position information acquisition unit that acquires a vehicle position, which is a current position of the vehicle, a driving information acquisition unit that acquires driving information related to a driving state of the vehicle, a surrounding information acquisition unit that acquires surrounding information indicating targets positioned around the vehicle, a memory unit that stores a reference position, reference driving information, and reference surrounding information, which is surrounding information on a driving route from the reference position to a target position, in association with each other, and a control unit that performs driving assistance control to cause the vehicle to travel the driving route. In response to an accuracy of the vehicle position being equal to or less than a predetermined threshold accuracy, the control unit performs the driving assistance control using the surrounding information and the reference surrounding information associated with the reference position whose distance from the vehicle position is equal to or less than a predetermined threshold distance and the reference driving information whose similarity with the driving information is equal to or greater than a predetermined threshold similarity.

According to this type of driving assistance device, even if the accuracy of the vehicle position acquired by the position information acquisition unit is low, driving assistance control can be performed to cause the vehicle to travel along a driving route using reference surrounding information associated with a reference position corresponding to the current vehicle position and the current surrounding information.

### A. First Embodiment

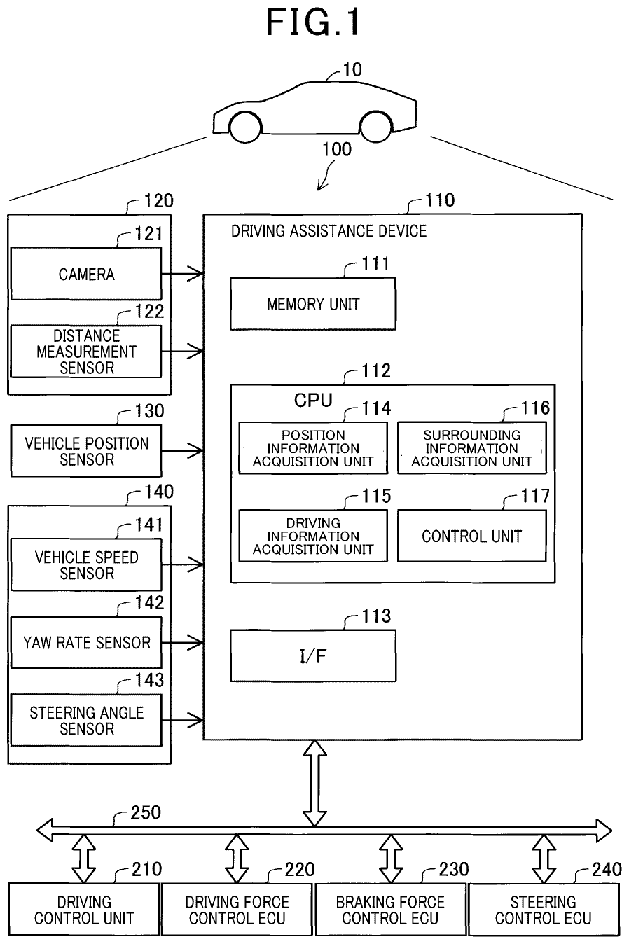

As shown in FIG. 1, a vehicle 10 is equipped with a driving assistance system 100. In the present embodiment, the driving assistance system 100 performs autonomous driving of the vehicle 10 as driving assistance. In the present embodiment, the driving assistance system 100 includes a driving assistance device 110, a surrounding sensor 120, a vehicle position sensor 130, a driving sensor 140, a driving control unit 210, a driving force control ECU (Electronic Control Unit) 220, a braking force control ECU 230, and a steering control ECU 240. The driving assistance device 110, the driving force control ECU 220, the braking force control ECU 230, and the steering control ECU 240 are connected via an in-vehicle network 250. Note that the vehicle 10 is not limited to autonomous driving of the vehicle, but may be a vehicle that can be driven manually by a driver.

The surrounding sensor 120 is a sensor for detecting targets positioned around the vehicle 10. The surrounding sensor 120 includes a camera 121 and a distance measurement sensor 122. The camera 121 captures images of the surroundings of the vehicle 10. The distance measurement sensor 122 measures the distance to objects around the vehicle 10. The distance measurement sensor 122 may be, for example, Lidar (Light Detection and Ranging) that uses reflected waves, millimeter wave radar, sonar, etc.

The vehicle position sensor 130 detects a current vehicle position of the vehicle 10. The vehicle position sensor 130 may be, for example, a sensor that receives a GNSS signal. In the present embodiment, the vehicle position sensor 130 also receives a reception strength of the GNSS signal, which is represented by the signal to noise ratio (SNR) and the carrier to noise density ratio (C/NO), as well as the positioning accuracy degradation factor (Dilution of Precision (DOP)).

The driving sensor 140 is a sensor for detecting a driving state of the vehicle 10. The driving sensor 140 includes a vehicle speed sensor 141, a yaw rate sensor 142, and a steering angle sensor 143. The vehicle speed sensor 141 measures a current driving speed of the vehicle 10. The yaw rate sensor 142 is a detector that detects a yaw rate (rotational angular velocity) around a vertical axis of the center of gravity of the vehicle 10. The steering angle sensor 143 is a detector that detects a steering angle of the vehicle 10.

The driving assistance device 110 is a device that controls traveling of the vehicle 10 and performs driving assistance. The driving assistance device 110 is configured by a computer including a memory unit 111 configured by a ROM and a RAM, a CPU 112, and an input/output interface 113. The memory unit 111, the CPU 112, and the input/output interface 113 are connected to each other so as to be able to communicate bidirectionally.

The memory unit 111 is configured by the ROM and the RAM. The memory unit 111 stores a predetermined reference position, reference driving information which is driving information at the reference position, and reference surrounding information which is surrounding information on a driving route from the reference position to a predetermined target position, in association with each other. The target position is a target position to which the vehicle 10 is to travel under the driving assistance of the driving assistance system 100, and is a position that can be determined arbitrarily. The target position is, for example, a parking lot near the home.

The reference position is a position where the driving information to be associated is significantly different from the driving information before and after the reference position, and is a position that can be determined arbitrarily. The reference position is preferably at a distance of 50 m or more and 200 m or less from the target position. In the present embodiment, the reference position is a vehicle position detected by the vehicle position sensor 130 when the vehicle 10 traveled toward the target position in the past. In addition, the reference driving information is driving information detected by the driving sensor 140 when the vehicle 10 traveled toward the target position in the past, and the reference surrounding information is surrounding information detected by the surrounding sensor 120. A process of preparing the reference position, the reference driving information, and the reference surrounding information in association with each other is also referred to as a preparation step.

The CPU 112 performs a program pre-installed in the memory unit 111 to realize the functions of a position information acquisition unit 114, a driving information acquisition unit 115, a surrounding information acquisition unit 116, and a control unit 117. However, some or all of the functions of these units may be realized by hardware circuits.

The position information acquisition unit 114 acquires a current vehicle position of the vehicle 10 from the vehicle position sensor 130. The position information acquisition unit 114 acquires, for example, coordinates indicating the latitude and the longitude of the position of the vehicle 10 as the vehicle position.

The driving information acquisition unit 115 acquires driving information relating to the driving state of the vehicle 10 detected by the driving sensor 140. In the present embodiment, the driving information includes information indicating the operation details of the vehicle 10. The operation details of the vehicle 10 include, for example, turning right or left, starting to reverse, stopping, and turning on turn signals.

The surrounding information acquisition unit 116 acquires surrounding information indicating the positions of targets positioned around the vehicle 10 detected by the surrounding sensor 120 mounted on the vehicle 10.

The control unit 117 performs driving assistance control of the vehicle 10 to travel along a predetermined driving route toward a predetermined target position. In the present embodiment, the control unit 117 performs automatic parking by driving the vehicle 10 toward a target position and parking it. In addition, in the present embodiment, the control unit 117 performs driving assistance control using a known localization technology that uses reference surrounding information associated with a reference position stored in the memory unit 111 corresponding to the current vehicle position and current surrounding information.

The driving control unit 210 is composed of a microcomputer configured with a central processing unit (CPU), a RAM, and a ROM, and realizes the autonomous driving function by the microcomputer performing a pre-installed program. The driving control unit 210 controls the driving force control ECU 220, the braking force control ECU 230, and the steering control ECU 240 in accordance with the control of the control unit 117, thereby realizing the autonomous driving function for traveling to the target position. The driving control unit 210 outputs, for example, a deceleration rate to the driving force control ECU 220 and the braking force control ECU 230, and outputs a steering angle to the steering control ECU 240, thereby automatically causing the vehicle 10 to change lanes.

The driving force control ECU 220 is an electronic control device that controls a power source that generates driving force for the vehicle 10, such as an engine. When the driver drives the vehicle manually, the driving force control ECU 220 controls the power source, which is the engine or an electric motor, in accordance with an amount of accelerator pedal operation. When autonomous driving is performed, the driving force control ECU 220 controls the output of the engine and the electric motor in accordance with the required driving force calculated by the driving control unit 210.

The braking force control ECU 230 is an electronic control device that controls a brake actuator that generates a braking force for the vehicle 10. When the driver drives the vehicle manually, the braking force control ECU 230 controls the brake actuator in accordance with an amount of operation of a brake pedal. When performing autonomous driving, the braking force control ECU 230 controls the brake actuator to control a brake hydraulic pressure according to the required braking force calculated by the driving control unit 210.

The steering control ECU 240 is an electronic control device that controls a motor that generates a steering torque for the vehicle 10. When the driver drives the vehicle manually, the steering control ECU 240 controls the motor in response to an operation of a steering wheel to generate an assist torque for the steering operation. This allows the driver to operate the steering wheel with a small amount of force, thereby realizing steering of the vehicle 10. When performing autonomous driving, the steering control ECU 240 performs steering by controlling the motor in accordance with the required steering angle calculated by the driving control unit 210.

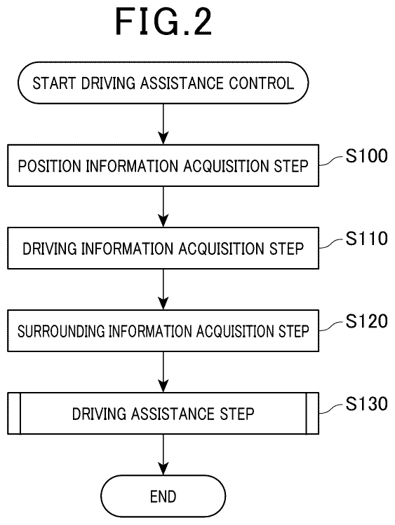

A driving assistance process shown in FIG. 2 is a process in which the control unit 117 performs driving assistance control of the vehicle 10 traveling toward a target position. This process is repeatedly performed by the driving assistance device 110 while the vehicle 10 is traveling, for example, every 100 ms.

In step S100, the position information acquisition unit 114 performs a position information acquisition step of acquiring a current vehicle position of the vehicle 10 from the vehicle position sensor 130.

In step S110, the driving information acquisition unit 115 performs a driving information acquisition step of acquiring the driving information from the driving sensor 140.

In step S120, the surrounding information acquisition unit 116 performs a surrounding information acquisition step of acquiring the surrounding information from the surrounding sensor 120. Note that steps S100 to S120 are not limited to this order and may be performed in any order, or may be performed in parallel.

In step S130, the control unit 117 selects the reference surrounding information to be used for driving assistance control based on the vehicle position of the vehicle 10 acquired in step S100, and performs a driving assistance step in which the vehicle 10 travels along the driving route using the surrounding information acquired in step S120 and the selected reference surrounding information. More specifically, the control unit 117 uses localization technology to match the surrounding information acquired in step S120 with the selected reference surrounding information to accurately determine the position and orientation of the vehicle 10, and controls the driving control unit 210 so that the vehicle 10 travels along the driving route.

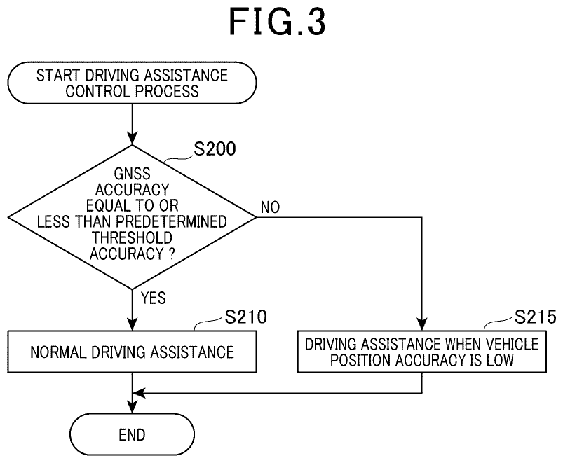

A driving assistance control process shown in FIG. 3 is a process in which the control unit 117 performs driving assistance for the vehicle 10 in step S130 (refer to FIG. 2) of the driving assistance process. First, in step S200, the control unit 117 determines whether an accuracy of the vehicle position acquired in step S100 (refer to FIG. 2) is equal to or less than a predetermined threshold accuracy. More specifically, the control unit 117 determines whether a degree of match between a position trajectory of the vehicle 10 acquired in step S100 and a movement trajectory of the vehicle 10 calculated from the vehicle speed, the yaw rate, etc. included in the driving information acquired in step S110 is below a predetermined threshold value. If the degree of match is equal to or less than the threshold, the control unit 117 determines that the accuracy of the vehicle position is equal to or less than the threshold accuracy. If the accuracy of the vehicle position is greater than the threshold accuracy, the control unit 117 proceeds to a process of step S210. On the other hand, if the accuracy of the vehicle position is equal to or less than the threshold accuracy, the control unit 117 proceeds to a process of step S215.

In step S210, the control unit 117 causes the vehicle 10 to travel along a driving route using the surrounding information acquired in step S120 (refer to FIG. 2) and the reference surrounding information associated with a reference position whose distance from the vehicle position acquired in step S100 (refer to FIG. 2) is equal to or less than a predetermined selection distance. The selection distance is 20 cm, for example.

In step S215, the control unit 117 causes the vehicle 10 to travel along a driving route using the surrounding information acquired in step S120 (refer to FIG. 2), a reference position whose distance from the vehicle position acquired in step S100 (refer to FIG. 2) is equal to or less than a predetermined threshold distance, and the reference surrounding information associated with the reference driving information whose similarity with the driving information at the vehicle position is greater than or equal to a predetermined threshold similarity.

The threshold distance is, for example, 20 m, which is the maximum distance error in positioning by GNSS. The threshold distance is preferably greater than the selection distance. The similarity is a value indicating a degree to which the driving information is similar. In the present embodiment, the threshold similarity is, for example, a similarity at which it can be determined that the operation details of the vehicle 10 indicated by the drive information are similar.

That is, in step S215, the control unit 117 selects surrounding information that is highly likely to be similar to the current surrounding information as reference surrounding information to be used for driving assistance control.

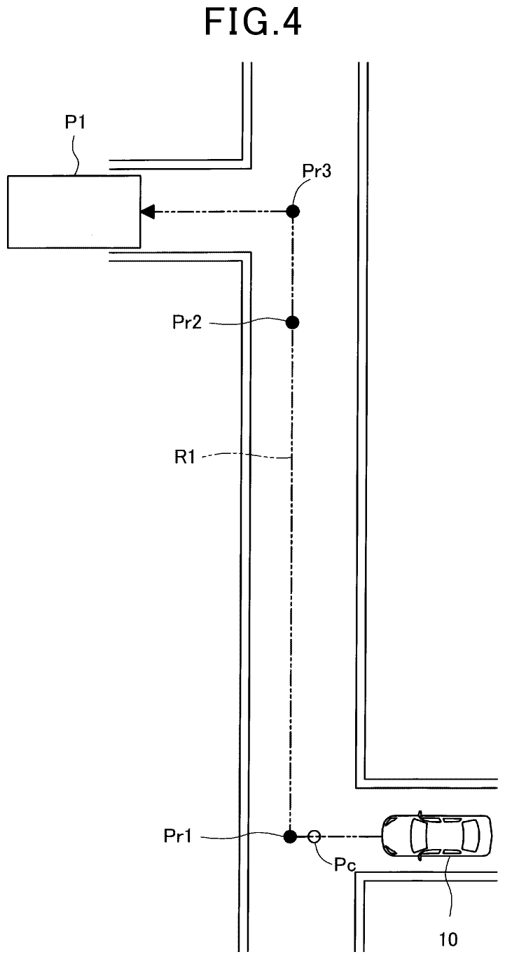

As shown in FIG. 4, a driving assistance control process for causing the vehicle 10 to travel along a driving route R1 to a target position P1 will be described. In the following, a case will be described as an example in which the vehicle 10 is positioned at a first reference position Pr1 and an accuracy of the vehicle position acquired by the position information acquisition unit 114 at this time is equal to or less than the threshold accuracy. The vehicle position acquired by the position information acquisition unit 114 indicates a position Pc whose distance from the first reference position Pr1 is equal to or less than the threshold distance.

In addition, in the following description, a case will be described as an example in which the memory unit 111 stores a plurality of reference positions, reference surrounding information, and reference driving information in association with each other. More specifically, the memory unit 111 stores a correspondence between the first reference position Pr1, first reference surrounding information, and first reference driving information, a correspondence between a second reference position Pr2, second reference surrounding information, and second reference driving information, and a correspondence between a third reference position Pr3, third reference surrounding information, and third reference driving information. An nth reference surrounding information is surrounding information at an nth reference position Prn, and nth reference driving information is driving information at the nth reference position Prn (n is an integer from 1 to 3). The first reference position Pr1, the second reference position Pr2, and the third reference position Pr3 are all positioned on the driving route R1.

The control unit 117 determines whether the similarity between first reference driving information and the driving information acquired by the driving information acquisition unit 115 is equal to or greater than a threshold similarity. When the vehicle 10 is traveling toward the target position P1, the traveling details of the vehicle 10 are likely to be similar to the traveling details of the driving route R1, and therefore, if the similarity between the reference traveling information and the traveling information is high, there is a high probability that the vehicle 10 is positioned at the reference position Pc corresponding to the reference driving information. In other words, if the first reference driving information indicates a right turn and the driving information acquired by the driving information acquisition unit 115 also indicates a right turn, there is a high probability that the actual vehicle position of the vehicle 10 is not the position Pc but the first reference position Pr1.

Therefore, the control unit 117 can select the first reference surrounding information associated with the first reference position Pr1, which is highly likely to be the actual vehicle position of the vehicle 10, as the reference surrounding information to be used for driving assistance control. As a result, the control unit 117 can cause the vehicle 10 to travel along the driving route R1 using the localization technique that compares the first reference surrounding information with the surrounding information acquired by the surrounding information acquisition unit 116.

Note that if the similarity between the first reference driving information and the driving information acquired by the driving information acquisition unit 115 is less than the threshold similarity, the control unit 117 terminates the driving assistance control process. In other words, when a reference position that is highly likely to be the actual vehicle position of the vehicle 10 is not stored in the memory unit 111, the control unit 117 suppresses performing driving assistance control using reference surrounding information that is associated with a reference position that is unlikely to be the actual vehicle position of the vehicle 10. Then, the control unit 117 determines whether the similarity between the first reference driving information and the driving information acquired by the driving information acquisition unit 115 is greater than or equal to the threshold similarity while the distance between the vehicle position acquired by the position information acquisition unit 114 and the first reference position Pr1 is less than or equal to the threshold distance. In addition, if the distance between the vehicle position acquired by the position information acquisition unit 114 and the second reference position Pr2 is less than or equal to the threshold distance, the control unit 117 determines whether the similarity between the second reference driving information and the driving information acquired by the driving information acquisition unit 115 is greater than or equal to the threshold similarity.

According to the driving assistance device 110 of the present embodiment described above, even if the accuracy of the vehicle position acquired by the position information acquisition unit 114 is low, driving assistance control can be performed to cause the vehicle 10 to travel along the driving route R1 using the reference surrounding information associated with the reference position corresponding to the current vehicle position and the current surrounding information.

In addition, using the travel information, it is possible to select the reference surrounding information that is associated with the reference position that is highly likely to be the current position of the vehicle 10. Therefore, compared to when reference surrounding information is selected using only surrounding information or when reference surrounding information is selected using map information, the complexity and cost of processing can be reduced.

### B. Other Embodiments

(B1) In the embodiment described above, the driving assistance device 110 is mounted on the vehicle 10. Without being limited to this, the driving assistance device 110 may be provided, for example, in a server provided outside the vehicle 10 or in transportation infrastructure.
(B2) In the embodiment described above, the driving sensor 140 includes the vehicle speed sensor 141 and the yaw rate sensor 142. Without being limited to this, the driving sensor 140 may also include an acceleration sensor.
(B3) In the embodiment described above, the position information acquisition unit 114 acquires the current vehicle position of the vehicle 10 from the vehicle position sensor 130. Without being limited to this, the input/output interface 113 may obtain an estimated vehicle position using position information obtained from road facilities such as traffic lights and electronic bulletin boards, and communication devices installed in commercial facilities and public facilities, and the positional relationship between the vehicle 10 and them.
(B4) In the embodiment described above, the driving assistance process is a process that is repeatedly performed while the vehicle 10 is traveling by autonomous driving. Without being limited to this, the driving assistance process may be performed at the start of autonomous driving in which the vehicle 10 travels from a predetermined starting point to a destination point. In this case, the control unit 117 performs the driving assistance process when the control unit 117 determines that the vehicle 10 is positioned near the starting point.
(B5) In the embodiment described above, the accuracy of the vehicle position is the degree of match between a trajectory of the position of the vehicle 10 detected by the vehicle position sensor 130 and a movement trajectory of the vehicle 10. Without being limited to this, the accuracy of the vehicle position may be expressed by an error ellipse. In this case, the control unit 117 determines whether an area of the error ellipse is equal to or greater than a predetermined threshold, and if the area of the error ellipse is equal to or greater than the threshold, the control unit 117 determines that the accuracy of the vehicle position is equal to or less than the threshold accuracy. In addition, the accuracy of the vehicle position may be, for example, the degree of match between a current coordinate position of the vehicle 10 obtained from the vehicle position sensor 130 and a current coordinate position of the vehicle 10 estimated using map information and surrounding information. Further, the accuracy of the vehicle position may also be a DOP (Dilution of Precision) value received by the vehicle position sensor 130. In this case, the control unit 117 determines whether the DOP value is equal to or greater than a predetermined threshold value, and if the DOP value is equal to or greater than the threshold value, the control unit 117 determines that the accuracy of the vehicle position is equal to or less than the threshold accuracy. In addition, the accuracy of the vehicle position may also be the strength of a GNSS signal received by the vehicle position sensor 130. In this case, the control unit 117 determines whether the reception strength of the GNSS signal is equal to or less than a predetermined threshold, and if the reception strength of the GNSS is equal to or less than the threshold, the control unit 117 determines that the accuracy of the vehicle position is equal to or less than the threshold accuracy. In addition, the accuracy of the vehicle position may be a value determined according to predetermined parameters. The parameters include, for example, the weather and the number of other vehicles traveling around the vehicle 10. When weather is used as a parameter, an accuracy of the vehicle position in fine weather may be set to a higher value than an accuracy of the vehicle position in rainy weather. In addition, when the number of other vehicles traveling around vehicle 10 is used as a parameter, an accuracy of the vehicle position may be calculated, for example, based on a map or function that defines the relationship between the number of other vehicles traveling around vehicle 10 and the accuracy. Further, the accuracy of the vehicle position may also be set by combining these.
(B6) In the embodiment described above, the driving information is information indicating the operation details of the vehicle 10. In addition, the similarity is a value indicating the degree to which the operation details of the vehicle 10 indicated by the travel information are similar. Without being limited to this, the travel information may be, for example, information indicating changes in gradient of the road on which the vehicle 10 is traveling.
(B7) In the driving assistance control process of the embodiment described above, the control unit 117 may correct the vehicle position. More specifically, in response to the accuracy of the vehicle position being equal to or less than the threshold accuracy, the control unit 117 may correct the vehicle position acquired by the position information acquisition unit 114 in step S215 (refer to FIG. 3) using the reference surrounding information used for driving assistance control and the reference position associated with that reference surrounding information.

The present disclosure is not limited to the embodiments described above, and can be realized in various configurations without departing from the object of the present disclosure. For example, the technical features in the embodiments corresponding to the technical features in each form described in the SUMMARY section may be replaced or combined as appropriate in order to solve the above-mentioned problems or to achieve some or all of the above-mentioned effects. Further, if a technical feature is not described as essential in the present specification, it may be deleted as appropriate.

A driving assistance device 110 and methods described in the present disclosure may be realized by a dedicated computer provided by configuring a processor and memory programmed to perform one or more functions embodied by the computer program. Alternatively, the driving assistance device and method described in the present disclosure may be implemented by a dedicated computer provided by configuring a processor with one or more dedicated hardware logic circuits. Alternatively, the driving assistance device and methods described in the present disclosure may be realized by one or more dedicated computers composed of a processor and memory programmed to perform one or more functions, in combination with a processor composed of one or more hardware logic circuits. In addition, the computer program may also be stored in a computer-readable, non-transitory tangible storage media as instructions to be performed by a computer.

What is claimed is:

1. A driving assistance device comprising:
a position information acquisition unit that acquires a vehicle position, which is a current position of the vehicle;
a driving information acquisition unit that acquires driving information related to a driving state of the vehicle;
a surrounding information acquisition unit that acquires surrounding information indicating targets positioned around the vehicle;
a memory unit that stores the following in association with each other:
a reference position;
reference driving information, which is the driving information at the reference position; and
reference surrounding information, which is the surrounding information on a predetermined driving route from the reference position to a predetermined target position; and
a control unit that performs driving assistance control to cause the vehicle to travel along the driving route; wherein
in response to an accuracy of the vehicle position being equal to or less than a predetermined threshold accuracy, the control unit performs the driving assistance control using:
the surrounding information; and
the reference surrounding information associated with the reference position whose distance from the vehicle position is equal to or less than a predetermined threshold distance and the reference driving information whose similarity with the driving information is equal to or greater than a predetermined threshold similarity.

2. The driving assistance device according to claim 1, wherein
the driving information includes information indicating operation details of the vehicle, including at least one of right turn, left turn, start of reverse, stop, and turn on of a turn signal.

3. The driving assistance device according to claim 1, wherein
in response to the accuracy of the vehicle position being equal to or less than the threshold accuracy, the control unit corrects the vehicle position using:
the surrounding information; and
the reference position and the reference surrounding information associated with the reference driving information at the reference position whose distance from the vehicle position is equal to or less than the threshold distance and whose similarity with the driving information at the vehicle position is equal to or greater than the threshold similarity.

4. The driving assistance device according to claim 2, wherein
in response to the accuracy of the vehicle position being equal to or less than the threshold accuracy, the control unit corrects the vehicle position using:
the surrounding information; and
the reference position and the reference surrounding information associated with the reference driving information at the reference position whose distance from the vehicle position is equal to or less than the threshold distance and whose similarity with the driving information at the vehicle position is equal to or greater than the threshold similarity.

5. A driving assistance device comprising:
one or more processors; and
a memory storing instructions that when performed by the one or more processors causes the driving assistance device to perform:
acquiring a vehicle position, which is a current position of the vehicle;
acquiring driving information related to a driving state of the vehicle;
acquiring surrounding information indicating targets positioned around the vehicle;
storing the following in association with each other:
a reference position;
reference driving information, which is the driving information at the reference position; and
reference surrounding information, which is the surrounding information on a predetermined driving route from the reference position to a predetermined target position; and
controlling to cause the vehicle to travel along the driving route; wherein
in response to an accuracy of the vehicle position being equal to or less than a predetermined threshold accuracy, the driving assistance control is controlled using:
the surrounding information; and
the reference surrounding information associated with the reference position whose distance from the vehicle position is equal to or less than a predetermined threshold distance and the reference driving information whose similarity with the driving information is equal to or greater than a predetermined threshold similarity.

6. A driving assistance method comprising:
a position information acquisition step of acquiring a vehicle position, which is a current position of the vehicle;
a driving information acquisition step of acquiring driving information relating to a driving state of the vehicle;
a surrounding information acquisition step of acquiring surrounding information indicating targets positioned around the vehicle;
a preparation step of preparing a reference position, reference driving information, which is the driving information at the reference position, and reference surrounding information, which is the surrounding information on a predetermined driving route from the reference position to a predetermined target position, in association with each other; and
a driving assistance step of performing driving assistance control to cause the vehicle to travel along the driving route, wherein
in response to an accuracy of the vehicle position being equal to or less than a predetermined threshold accuracy, the driving assistance step performs the driving assistance control using:
the surrounding information; and
the reference surrounding information associated with the reference position whose distance from the vehicle position is equal to or less than a predetermined threshold distance, and the reference driving information whose similarity with the driving information at the vehicle position is equal to or greater than a predetermined threshold similarity.
